(19) United States
(12) Patent Application Publication
(10) Pub. No.: US 2009/0206593 A1
(43) Pub. Date: Aug. 20, 2009

(54) SLIDEABLE WINDOW BOOK WITH FLAPS

(75) Inventor: Steven C. Prescott, Santa Rosa, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Transglobal Communications Group, Inc., Santa Rosa, CA (US)

(21) Appl. No.: 12/031,142

(22) Filed: Feb. 14, 2008

(51) Int. Cl. B42D 15/00; A63H 33/38

(52) U.S. Cl. 283/67; 283/64; 446/151; 446/147; 283/63.1

(57) ABSTRACT

A printed work, such as a book or a card, may include one or may pages having a first layer having an image on a surface thereof, a second layer covering at least a portion of the first layer and having a flap configured to move between a closed position, in which the image is covered by the flap, and an open position, in which the flap exposes the image, and a third layer covering the second layer and having a portion being movable relative to the second layer to expose the flap. Methods of displaying such a printed work are also disclosed.

### BACKGROUND OF THE INVENTION

The invention is directed to children's books, and more particularly, to a book with a slideable portion that can be moved by a user to expose a hidden layer, where the hidden layer can include one or more flaps which themselves can cover or uncover different images.

Various attempts have been made to introduce children to reading and make the reading experience more stimulating and enjoyable, especially for young children. It has been found that illustrations play an important role in attracting and maintaining a child's interest in reading. Hence, children's story books have been provided with large, colorful pictures illustrating the subject matter or the background thereof. Books with pages having movable portions have been a very popular choice among parents and children because these books include movable portions that provide surprise and amusement to the children.

Books having movable portions such as slides or flaps are known. For example, U.S. Pat. No. 5,580,098 (hereafter “Gates”) discloses a children's book having a movable portion, which can be slidably moved to expose the underlying layer. However, Gates does not disclose a flap and an image covered by the flap. Similarly, U.S. Pat. No. 5,871,237 (hereafter “Hunt”) shows a children's book having a rotatable portion. However, Hunt does not show a flap and an image covered by a flap.

The ability to continue to stimulate a child's imagination has been limited by currently available books, as such books provide limited functionalities which children can get bored with quickly.

### BRIEF SUMMARY OF THE INVENTION

The invention improves upon commercially available books by providing a book having a page that has a slideable portion that can be moved by a user to expose a hidden layer, where the hidden layer can include one or more flaps which themselves can cover different images. The invention may be implemented in a number of ways, and is not limited to books, but may be used in various other implementations, including cards and similar consumer products.

According to one aspect of the invention, a printed work may include a first layer having an image on a surface thereof, a second layer covering at least a portion of the first layer and having a flap that can move between a closed position, in which the image is covered by the flap, and an open position, in which the flap exposes the image, and a third layer covering the second layer and having a portion being movable relative to the second layer to expose the flap.

The third layer may include a stationary portion and the movable portion can move between a normal position, in which the movable portion is arranged proximate the stationary portion to at least partially cover the second layer, and an extended position, in which the movable portion is separated from the stationary portion to expose at least a portion of the second layer.

The flap may be configured to pivotally move between the closed position and the open position. The flap may be one of several flaps that are exposed when the third layer is in its extended position. The flap may be movable to the open position when the third layer is in its extended position.

The movable portion may include a surface to engage the flap and automatically return the flap to the closed position as the movable portion returns to the normal position from the extended position. The movable portion may be slideably movable between the normal position and the extended position.

The movable portion when it is arranged proximate the stationary portion may substantially completely cover the second layer.

The printed work can be a part of a book or a card.

The first, second and third layers may be connected to form a page. Alternatively, multiple first, second and third layers may be connected together to form a plurality of pages.

According to another aspect of the invention, a method of displaying a printed work having at least one page including a first layer having an image on a surface thereof, a second layer covering at least a portion of the first layer and having a flap, and a third layer covering the second layer and having a portion being movable relative to the second layer, includes the steps of: disposing the page in a position for reading, moving the movable portion relative to the second layer to expose the flap, and moving the flap to the open position to expose the image.

Moving the flap to the closed position may be achieved by moving the movable portion to the normal position.

The first layer may have multiple images, the second layer may have a plurality of flaps covering the images, and the moving of the flaps to their open position can expose the images. Furthermore, the flaps may be closed by moving the movable portion to the normal position.

According to yet another aspect of the invention, the printed work may include a surface having an image thereon, first means for covering the image, second means for covering the first means, and means for moving the second means relative to first means to permit the first means to at least partially expose the image. The printed work can be a part of a book or a card.

The first means may include a flap configured to move between a closed position, in which the image is covered by the flap and an open position, in which the flap exposes the image. The first means may include a layer including a living hinge forming part of the flap. The second means may include a movable portion, operable to close the flap, and a stationary portion.

The printed work may include a multi-layered page, with the surface having an inner layer, the first means including an intermediate layer, the second means including a third layer, and the means for moving including a slideable engagement between the intermediate and an outer layer.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 illustrates a plan view of one page of an exemplary children's book constructed in accordance with the principles of the invention;

FIG. 2 illustrates a plan view of the page of FIG. 1, with the slidingly movable portion moved to expose a hidden layer;

FIG. 3 illustrates a plan view of the page of FIG. 1, in a position showing all the flaps on the hidden layer;

FIG. 4 illustrates a plan view of the page of FIG. 1, showing a flap in an open position;

FIG. 5 illustrates an enlarged, cross sectional view of the page of FIG. 1 taken along lines 5-5 in FIG. 1, showing the layers composing the page; and

FIG. 6 illustrates an enlarged, cross sectional view of the page of FIG. 3 taken along lines 6-6 in FIG. 3, showing the layers composing the page.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The embodiments of the invention may be implemented in a variety of ways, such as children's books, cards, promotional booklets or other readable consumer products or the like having a slidingly movable portion that can be moved or pulled by a user to expose a hidden layer. Furthermore, one or more flaps are disposed in the hidden layer. The flaps can cover or expose other hidden images or layers.

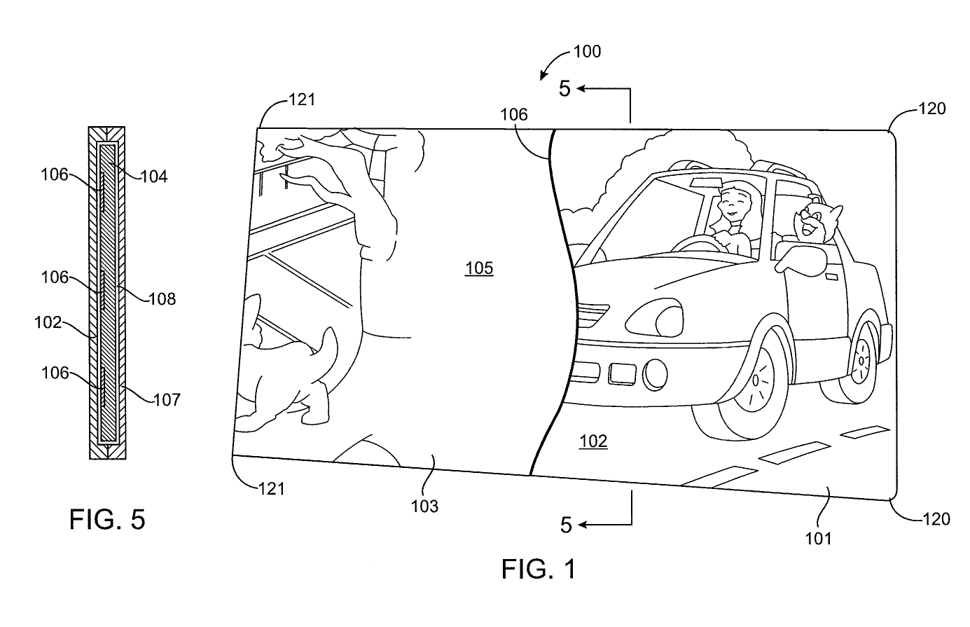

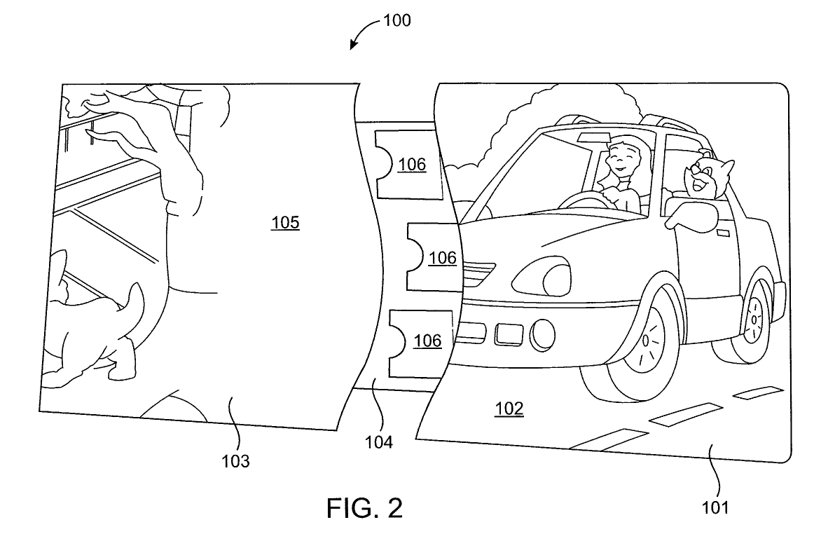

FIG. 1 illustrates one page of an exemplary children's book 100 made in accordance with the principles of the invention. For ease of reference, this description will refer to the disclosed embodiment as a book, but it may be implemented in various other ways as disclosed herein. On initial glance the page 100 shown in FIG. 1 looks like any ordinary page of a book. As is shown in FIG. 1, the page of the book 100 can include illustrations and other printed readable material, such as those available in children's books. However, as shown in FIG. 2, at least one page 100 of the book can have a slidingly movable portion 101 that is movable to the right to expose a hidden layer 104. The page of FIG. 1 is shown shaped like a parallelogram. The page can include rounded edges 120. The round edges 120 can provide for a more pleasant feel as the pages are grasped and turned. The page can also include square edges. The square edges 121 can be more suitable for binding the pages with other pages adjacent a spine to form a book. It should be realized that the page that is constructed in accordance with the principles of the invention can be constructed in any shape and can have rounded or squared edges. For example, the page in a plan view can have a rectangular, square, trapezoid, parallelogram, round, oval or any other shape.

FIG. 2 illustrates the page of FIG. 1 with the slidingly movable portion 101 moved relative to the stationary portion 103 to expose a hidden layer 104. As is shown in FIG. 2, the movable portion 101 is movable between a closed position shown in FIG. 1, in which the movable portion 101 is directly adjacent the stationary portion 103 to cover the hidden layer 104, and an extended position, in which the movable portion 101 is separated from the stationary portion 103 to expose at least a portion of the hidden layer 104. The movable portion 101 when it is directly adjacent the stationary portion 103 may completely or partially cover the hidden layer 104. The movable portion 101 may slide relative to the stationary portion by a user pulling on the movable portion 101 to move it away from the stationary portion 103. In one embodiment, the slide mechanism is made by a multi-layer page, where an inner layer is disposed between an upper and a lower layer as shown best in FIG. 5. In reference to FIG. 2, the middle layer is layer 104, and the upper layer is formed by portions 102, 105, and the lower layer is formed by portions 107, 109 (not visible in FIG. 1) disposed on the opposite side by layers 102, 105, respectively. The upper and lower layers are divided to form the portion 101 that is to be movable and the portion 103 that is to be stationary. As is shown in FIG. 2, the movable 101 and the stationary 103 portions are divided along a curved edge 106. However, it should be realized that the edge can have any shape. For example, the edge can be a straight line that is perpendicular to the upper and lower edges of the page, or the edge can be a stepped edge having a stair-step shape, or the edge can be an edge that is angled with respect to the upper or lower edge of the page.

The layers are arranged to form a composite multi-layer structure as shown in FIG. 5 in which the middle layer 104 is surrounded by cut-outs in layers 102, 107 and 105, 109, which form a cavity 108 in which the middle layer 104 is contained. The inner and outer layers 102, 107 and 105, 109, respectively, may be fixedly connected by glue or any other means known in the art. The middle layer 104 is fixed to the stationary layers 105, 109 by any means known on the art permitting movable layers 102, 107 to slide over middle layer 104. Thus, in operation, when a user pulls on the outer (i.e. upper and lower layers 102, 107) portion 101, the movable outer portion extends outwardly relative to the stationary portion 103 to expose the inner hidden layer 104. The movable portion 101 can be configured to engage a surface of the inner layer to limit the extent of the movable portion's travel relative the stationary portion and form a stop preventing layers 102, 107 from sliding completely off the middle layer. Other mechanisms known in the art to accomplish the relative movement between a stationary portion and a movable portion may be employed.

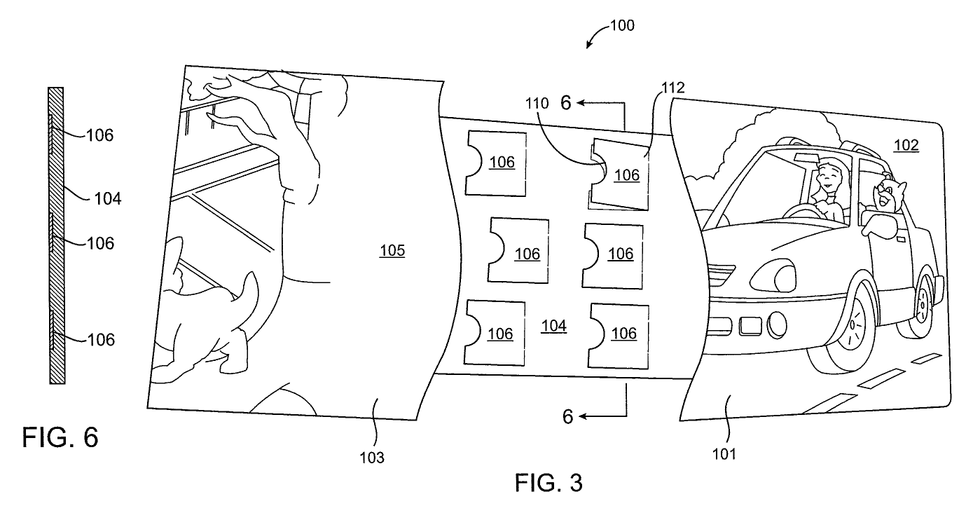

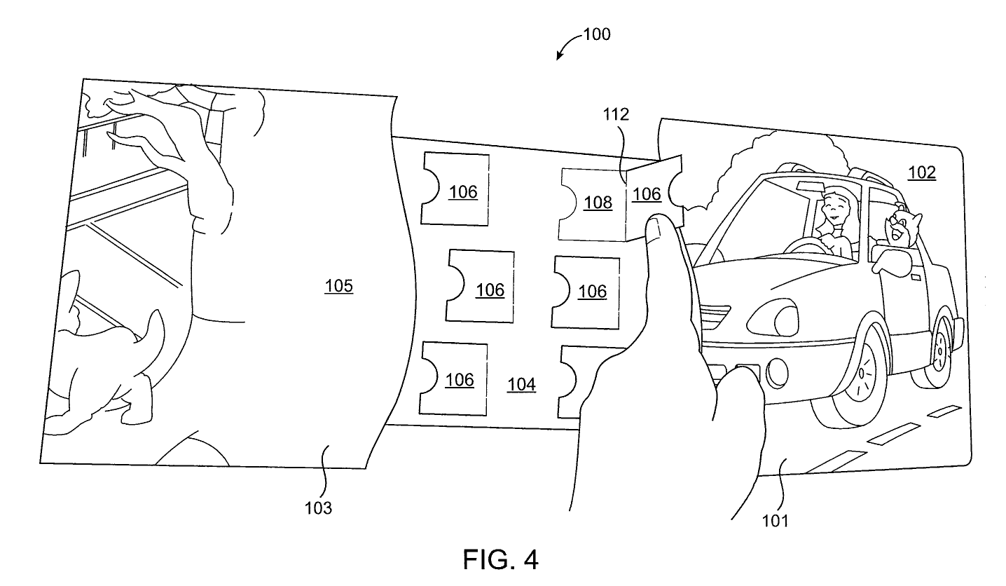

FIG. 3 illustrates the page 100 of FIG. 1, showing the flaps 106 on the hidden layer 104. As shown in FIG. 3, the hidden layer 104 may have one or more flaps 106, on the surface thereof to cover another hidden layer 108 (shown in FIG. 4), which may be exposed by opening the flaps. As is shown in FIG. 3, the flaps 106 are configured to pivotally move between a closed position shown in FIG. 3, in which the image is covered by the flap 106 and an open position shown in FIG. 4, in which the flap 106 is pivotally moved to expose an image. The flaps 106 can be formed in the hidden layer 104 by any means known in the art, such as by forming the hidden layer 104 as a multilayer sheet, and then by forming cuts on the top-most layer of the hidden layer down to the next lower layer, as shown in FIG. 6. By forming the cuts in less than all the sides of the flap, the remaining edge 112 forms a living hinge about which the flap can be opened. An additional cutout 110 shown in FIG. 3 can be formed on the edge of the flap that may be used by the user to aid the grasping of the flap.

FIG. 4 illustrates the page of FIG. 1, showing a flap 106 in an open position. As shown in FIG. 4, the flaps 106 can be positioned with the living hinge adjacent the movable portion 101 such that as the slidingly movable portion 101 is pushed back to its closed position, the flaps 106 automatically return to their original closed position without interfering with the movement of the slidingly movable portion 101.

As can be seen in FIGS. 1-4, the flap 106 is exposed and is movable to the open position when the movable portion 101 is at least partially extended. The flaps when opened can expose other printed materials, illustrations, numbers, answers to questions, and so on. For example, a question may be posed on the outside of the flap asking the reader to guess an answer, and that answer may be illustrated or printed on the surface that is exposed when the flap is opened. Alternatively, the flaps could be used to form the so called memory or concentration game, where the user is trying to match like figures, numbers or illustrations that are hidden beneath the flaps. In this manner the reader of the book is presented with near endless possibilities that can amuse and stimulate the reader.

The page illustrated in FIGS. 1-4 can be one of many pages that are constructed in accordance with the principles of the invention, and such pages can be bound together to form a book. The techniques used to bind the pages to form a book can include any binding process known in the art; and the book can include a front and a back cover.

While the invention has been described in terms of exemplary embodiments, those skilled in the art will recognize that the invention can be practiced with modifications in the spirit and scope of the appended claims. For example, while the invention is described and illustrated herein in the form of a book, it may be implemented in a number of other devices, such as hinged, flap-type consumer products (e.g., greeting cards or the like). These examples given above are merely illustrative and are not meant to be an exhaustive list of all possible designs, embodiments, applications or modifications of the invention.

What is claimed is:

1. A printed work, comprising:
a first layer having an image on a surface thereof;
a second layer covering at least a portion of the first layer and having a flap configured to move between a closed position, in which the image is covered by the flap, and an open position, in which the flap exposes the image; and
a third layer covering the second layer and having a portion being movable relative to the second layer to expose the flap.

2. The printed work of claim 1, wherein the third layer includes a stationary portion and said movable portion can move between a normal position, in which the movable portion is arranged proximate the stationary portion to at least partially cover the second layer, and an extended position, in which the movable portion is separated from the stationary portion to expose at least a portion of the second layer.

3. The printed work of claim 1, wherein the flap is configured to pivotally move between the closed position and the open position.

4. The printed work of claim 2, wherein the flap comprises a plurality of flaps that are exposed when the third layer is in its extended position.

5. The printed work of claim 2, wherein the flap is movable to the open position when the third layer is in its extended position.

6. The printed work of claim 2, wherein the movable portion includes a surface to engage the flap and automatically return the flap to the closed position as the movable portion returns to the normal position from the extended position.

7. The printed work of claim 2, wherein the movable portion is slideably movable between the normal position and the extended position.

8. The printed work of claim 2, wherein the movable portion when arranged proximate the stationary portion substantially completely covers the second layer.

9. The printed work of claim 1, wherein the printed work comprises one of a book and a card.

10. The printed work of claim 9, wherein the first, second and third layers are connected to form a page.

11. The printed work of claim 10, wherein multiple first, second and third layers are connected together to form a plurality of pages.

12. A method of displaying a printed work having at least one page including a first layer having an image on a surface thereof, a second layer covering at least a portion of the first layer and having a flap, and a third layer covering the second layer and having a portion being movable relative to the second layer, said method comprising the steps of:
disposing the page in a position for reading;
moving the movable portion relative to the second layer to expose the flap; and
moving the flap to the open position to expose the image.

13. The method of claim 12, further comprising moving the flap to the closed position by moving the movable portion to the normal position.

14. The method of claim 12, wherein the first layer has multiple images, the second layer has a plurality of flaps covering the images, and further comprising the step of moving the flaps to their open position to expose the images.

15. The method of claim 14, further comprising the step of closing the flaps by moving the movable portion to the normal position.

16. A printed work, comprising:
a surface having an image thereon;
first means for covering the image;
second means for covering the first means; and
means for moving the second means relative to first means to permit the first means to at least partially expose the image.

17. The printed work of claim 16, wherein said first means comprises a flap configured to move between a closed position, in which the image is covered by the flap and an open position, in which the flap exposes the image.

18. The printed work of claim 17, wherein said second means comprises a movable portion, operable to close the flap, and a stationary portion.

19. The printed work of claim 17, wherein said first means comprises a layer including a living hinge forming part of the flap.

20. The printed work of claim 16, wherein the printed work comprises a multi-layered page, with the surface comprising an inner layer, the first means comprising an intermediate layer, the second means comprising a third layer, and the means for moving comprising a slideable engagement between the intermediate and outer layer.

21. The printed work of claim 16, wherein the printed work comprises one of a book and a card.
